(19) United States
(12) Patent Application Publication
(10) Pub. No.: US 2020/0013113 A1
(43) Pub. Date: Jan. 9, 2020

(54) SEPARATE DRIVING ASSISTANCE APPARATUS AND SERVER

(71) Applicant: HONDA MOTOR CO., LTD., Tokyo (JP)

(72) Inventors: Yasuaki TEZUKA, Wako-shi (JP); Shinya TAKAHASHI, Wako-shi (JP); Shohei SUZUKI, Tokyo (JP)

(21) Appl. No.: 16/576,185

(22) Filed: Sep. 19, 2019

Related U.S. Application Data
(63) Continuation of application No. PCT/JP2017/013768, filed on Mar. 31, 2017.

(51) Int. Cl. G06Q 30/06; B62K 27/12; B62K 21/00; G06Q 10/08; G06Q 50/30

(52) U.S. Cl. CPC G06Q 30/0645; B62K 27/12; G06Q 50/30; G06Q 10/087; B62K 21/00

(57) ABSTRACT

A separate driving assistance apparatus connectable to a two-wheeled vehicle, the two-wheeled vehicle comprising a control block for controlling a driving operation, comprises a detection unit for detecting a traveling environment around the two-wheeled vehicle, and a control unit that outputs a controlling signal to the control block of the two-wheeled vehicle based on a detection result by the detection unit, the controlling signal being for assisting driving operation of the two-wheeled vehicle.

### CROSS-REFERENCE TO RELATED APPLICATION

This application is a continuation of International Patent Application No. PCT/JP2017/013768 filed on Mar. 31, 2017, the entire disclosures of which is incorporated herein by reference.

### TECHNICAL FIELD

The present invention relates to a separate driving assistance apparatus for a two-wheeled vehicle.

### BACKGROUND ART

As an example of four-wheeled vehicles, there is proposed a four-wheeled vehicle capable of performing some or all of driving operations such as acceleration, braking and steering on an ECU (electronic control unit) side, that is, driving assistance (Patent Literature 1). Various sensors are provided around the vehicle body, and the aforementioned driving assistance is executed based on a detection result of a traveling environment of the four-wheeled vehicle by these sensors.

### CITATION LIST

### Patent Literature

PTL1: Japanese Patent Laid-Open No. 2017-19308

### SUMMARY OF INVENTION

### Technical Problem

When the configuration capable of driving assistance is applied to a two-wheeled vehicle such as a straddle type motorcycle, disposition spaces for the various sensors for detecting the traveling environment become a problem, and therefore it is difficult to provide the various sensors in the same way as in the case of a four-wheeled vehicle.

An object of the present invention is to enable driving assistance of a two-wheeled vehicle with a relatively simple configuration.

### Solution to Problem

A first aspect of the present invention relates to a separate driving assistance apparatus connectable to a two-wheeled vehicle, the two-wheeled vehicle comprising a control block for controlling a driving operation, comprises a detection unit for detecting a traveling environment around the two-wheeled vehicle, and a control unit that outputs a controlling signal to the control block of the two-wheeled vehicle based on a detection result by the detection unit, the controlling signal being for assisting driving operation of the two-wheeled vehicle.

### Advantageous Effects of Invention

According to the present invention, driving assistance of a two-wheeled vehicle is enabled.

### BRIEF DESCRIPTION OF DRAWINGS

FIG. 1 is a view for explaining an example of a structure of a two-wheeled vehicle to which a separate driving assistance apparatus is connected.

FIG. 2 is a view for explaining an example of a structure of the two-wheeled vehicle to which the separate driving assistance apparatus is connected.

FIG. 3 is a diagram for explaining an example of a configuration of the two-wheeled vehicle to which the separate driving assistance apparatus is connected.

FIG. 4 is a diagram for explaining an example of a structure of the separate driving assistance apparatus.

FIG. 5 is a diagram for explaining an example of the structure of the two-wheeled vehicle.

FIG. 6 is a view for explaining an example of a mode of use of a rental service of the separate driving assistance apparatus.

FIG. 7 is a diagram for explaining a system configuration example of the rental service of the separate driving assistance apparatus.

### DESCRIPTION OF EMBODIMENT

Hereinafter, an embodiment of the present invention will be described with reference to the accompanying drawings. Note that the respective drawings are schematic views illustrating a structure or a configuration of the embodiment, and sizes of respective members which are illustrated do not necessarily reflect real sizes.

(Two-Wheeled Vehicle and Separate Driving Assistance Apparatus Connected to the Two-Wheeled Vehicle)

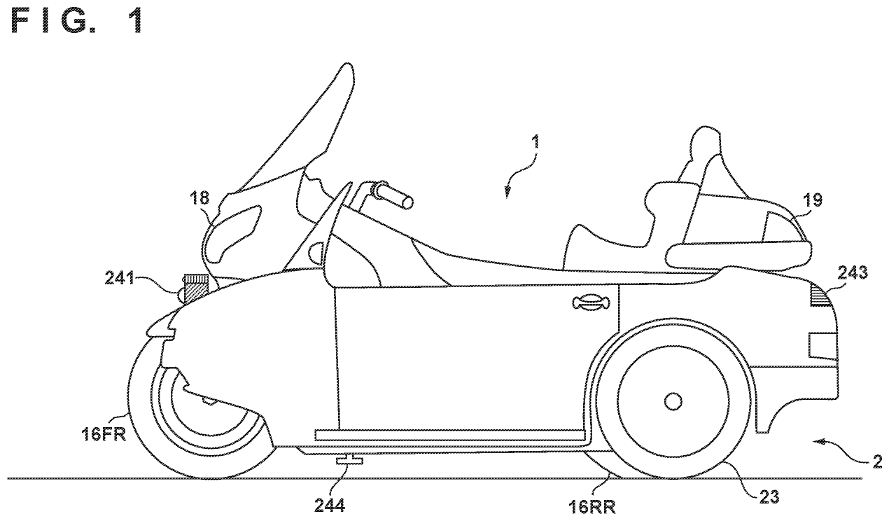

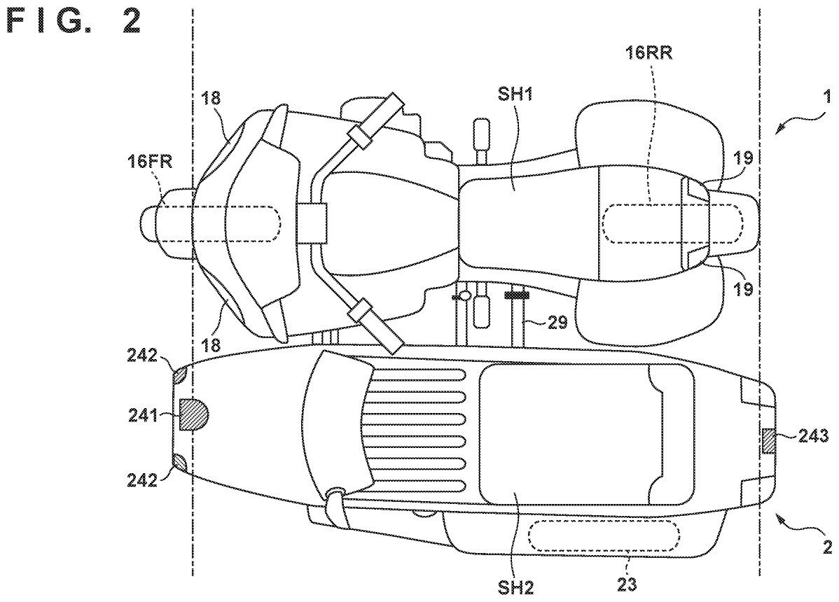

FIG. 1 and FIG. 2 are schematic views for explaining structures of a two-wheeled vehicle 1 and a separate driving assistance apparatus 2 according to the embodiment. FIG. 1 shows a side view (a view seen from a left side to a longitudinal direction of the two-wheeled vehicle 1) of the two-wheeled vehicle 1 and the separate driving assistance apparatus 2, and FIG. 2 shows a top view of the two-wheeled vehicle 1 and the separate driving assistance apparatus 2. The two-wheeled vehicle 1 is a straddle type motorcycle in the present embodiment. Although details will be described later, the separate driving assistance apparatus 2 is capable of performing driving assistance of the two-wheeled vehicle 1. The separate driving assistance apparatus 2 is a side car in the present embodiment, but can be any external type unit that is configured to be connectable to the two-wheeled vehicle 1. The two-wheeled vehicle 1 includes a seat SH1, and the separate driving assistance apparatus 2 includes a seat SH2, so that one or two persons including a driver can be passengers.

Note that in the following explanation, directions of “front”, “rear”, “left”, “right”, “up” and “down” are used to express relative positional relationships, and these directions are set with the longitudinal direction of the two-wheeled vehicle 1 as a reference. For example, the separate driving assistance apparatus 2 is connected to the two-wheeled vehicle 1 at a “left” side of the two-wheeled vehicle 1.

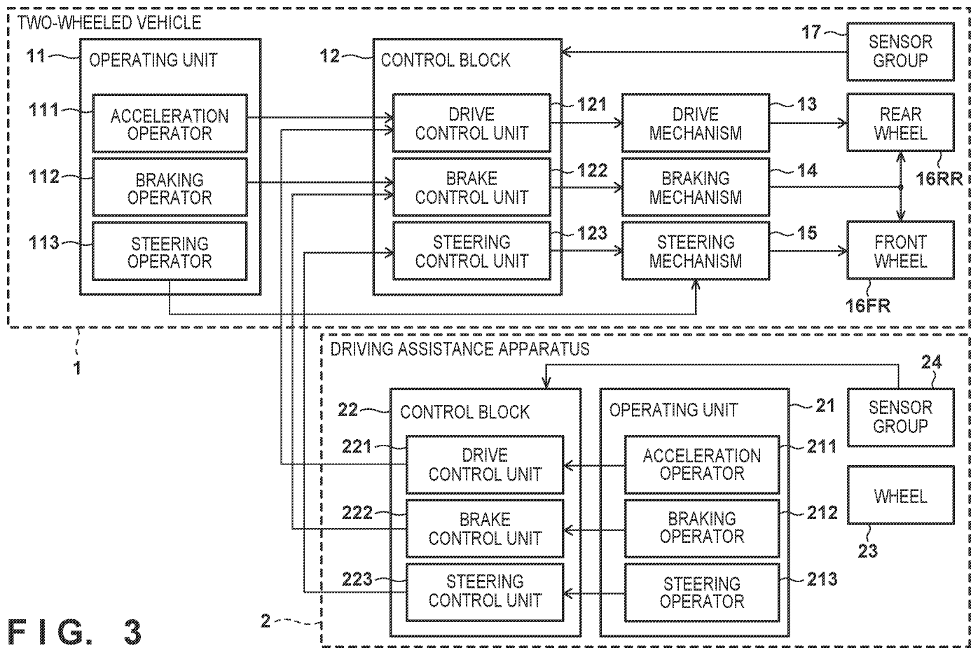

FIG. 3 is a block diagram for explaining a configuration of the two-wheeled vehicle 1 and the separate driving assistance apparatus 2. The two-wheeled vehicle 1 includes an operating unit 11, a control block 12, a drive mechanism 13, a braking mechanism 14, a steering mechanism 15, two wheels 16 (a front wheel 16FR, a rear wheel 16RR), and a sensor group 17.

The operating unit 11 includes an acceleration operator 111, a braking operator 112, and a steering operator 113. The acceleration operator 111 is an accelerator grip provided in a steering handle in the present embodiment. The braking operator 112 is a brake bar provided in the steering handle, and a brake pedal placed at a lower side of a vehicle body in the present embodiment. The steering operator 113 is a steering handle in the present embodiment.

The control block 12 is formed of a plurality of control units (for example, an ECU (electronic control unit)), and includes a drive control unit 121, a brake control unit 122, and a steering control unit 123 in the present embodiment. The drive control unit 121 controls the drive mechanism 13 based on an operation amount of the acceleration operator 111 by a driver. The drive mechanism 13 includes an engine unit and a transmission in the present embodiment. The brake control unit 122 controls the braking mechanism 14 based on an operation amount of the braking operator 112 by the driver. The braking mechanism 14 is a disk brake provided at the wheel 16, though details will be described later. The steering control unit 123 controls the steering mechanism 15 based on an operation amount of the steering operator 113 by the driver. The steering mechanism 15 is a head pipe and a front fork that are fixed to the steering handle and rotatable to the vehicle body in the present embodiment.

The sensor group 17 includes various sensors for detecting a state of the two-wheeled vehicle 1, such as a vehicle speed sensor for detecting a vehicle speed of the two-wheeled vehicle 1, and an acceleration sensor for detecting an acceleration of the two-wheeled vehicle 1. The control block 12 is capable of controlling the respective mechanisms based on detection signals from the sensor group 17. For example, the steering control unit 123 receives a detection signal indicating a posture (a steering angle, an inclination and the like) of the two-wheeled vehicle 1 from the sensor group 17, and can control the steering mechanism 15 based on the detection signals, though details will be described later.

The separate driving assistance apparatus 2 includes an operating unit 21, a control block 22, a wheel 23, and a sensor group 24 in the present embodiment. The operating unit 21 includes an acceleration operator 211, a braking operator 212 and a steering operator 213. In the present embodiment, the acceleration operator 211 and the braking operator 212 are pedal type operators (an accelerator pedal and a brake pedal), and the steering operator 213 is a steering wheel, though details will be described later.

The control block 22 is formed of a plurality of control units (for example, an ECU) similarly to the control block 12, and includes a drive control unit 221, a brake control unit 222, and a steering control unit 223 in the present embodiment. The control units 221 to 223 output control signals to the control block 12 of the two-wheeled vehicle 1 according to operation amounts of the operators 211 to 213. For example, the drive control unit 221 outputs a control signal based on an operation amount of the acceleration operator 211 by the driver to the drive control unit 121. For example, the brake control unit 222 outputs a control signal based on an operation amount of the braking operator 212 by the driver to the brake control unit 122. Further, for example, the steering control unit 223 outputs a control signal based on an operation amount of the steering operator 213 by the driver to the steering control unit 123.

The above described control units 221 to 223 each includes a CPU and a memory, for example, and outputs a control signal for driving or controlling a mechanism to be operated, based on an electric signal indicating an operation amount of a corresponding operator. Each of the control units may be configured by hardware, for example, a semiconductor integrated circuit such as ASIC (application specific integrated circuit), and PLD (programmable logic device), or software. Although the control units 221 to 223 are individually illustrated respectively here, the control units may be configured by a single unit as another embodiment. The control block 22 may further include another control unit for realizing another operation. Note that these contents also apply similarly to the control block 12 (the control units 121 to 123).

The wheel 23 supports the two-wheeled vehicle 1 and the separate driving assistance apparatus 2 which are connected to each other and realizes three-point grounding to a road surface, with the two wheels 16FR and 16RR of the two-wheeled vehicle 1. In other words, the wheel 23 helps the two-wheeled vehicle 1 stand up. Thereby, stabilization of the two-wheeled vehicle 1 at a traveling time is enabled.

The sensor group 24 includes various sensors for detecting a state of the separate driving assistance apparatus 2 such as a vehicle speed sensor and an acceleration sensor similarly to the sensor group 17, for example. For example, a vehicle speed (the vehicle speed is substantially equal to a vehicle speed of the two-wheeled vehicle 1) of the separate driving assistance apparatus 2 is detected based on the number of rotations per unit time of the wheel 23.

Further, the sensor group 24 includes various sensors for realizing a driving assistance function. For example, the sensor group 24 includes sensors capable of detecting a traveling environment around (in front, rear and the like) the two-wheeled vehicle 1 and the separate driving assistance apparatus 2 such as a camera (image sensor), a radar (millimeter wave radar). The traveling environment includes information necessary to perform driving such as other vehicles, obstacles, a state of a traveling surface, signs, and signals. Examples of the sensor are not limited to these examples, but other sensors such as a magnetic sensor (magnetic nail sensor) may be further provided.

In the present specification, the driving assistance indicates that the driving operation of the two-wheeled vehicle 1 to which the separate driving assistance apparatus 2 is connected, that is, a part or all of the aforementioned acceleration, braking and steering is not performed on a driver side, but is performed on a control block 22 side. In other words, in a driving assistance state, a subject of driving operation for at least a part of the acceleration, braking and steering is not a driver but the control block 22. The driving assistance functions are, for example, a vehicle speed control (auto cruise control) function, an inter-vehicle distance control (adaptive cruise control) function, a lane deviation prevention assistance (lane keep assist) function, a collision avoidance assistance function and the like, and concept of driving assistance also includes a so-called complete automated driving that performs all of the driving operations on the control block 22 side.

Referring to FIG. 1 and FIG. 2 again, in the present embodiment, the sensor group 24 includes a camera 241, radars 242 and 243, and a magnetic sensor 244. The camera 241 is placed at a front side of the separate driving assistance apparatus 2, and is capable of detecting a traveling environment in front, for example, a preceding vehicle that travels ahead of the two-wheeled vehicle 1, lane markings (a while line, a yellow line and the like) indicating a traveling lane and the like. The radar 242 is placed at a front side of the separate driving assistance apparatus 2, and is capable of detecting an obstacle or the like in front. The radar 243 is placed at a rear side of the separate driving assistance apparatus 2, and is capable of detecting an obstacle or the like in rear. Further, the magnetic sensor 244 is placed on a vehicle body bottom surface side of the separate driving assistance apparatus 2, and is capable of detecting a magnet that is provided on a traveling surface.

As can be seen from FIG. 2, in the present embodiment, the camera 241 and the radars 242 are disposed forward of a headlight 18 of the two-wheeled vehicle 1. Thereby, the camera 241 and the radars 242 can detect the traveling environment in front without detectable ranges thereof being narrowed by light of the headlight 18 and the headlight 18 itself. Further, the camera 241 and the radars 242 are more preferably disposed forward of a front cowl of the two-wheeled vehicle 1 as shown by a chain line in the drawing.

Further, as can be seen from FIG. 1, in the present embodiment, the camera 241 and the radars 242 are disposed upward of the front wheel 16FR. Thereby, it becomes possible to detect the traveling environment in front by the camera 241 and the radars 242 without detectable ranges of the camera 241 and the radars 242 being narrowed by the front wheel 16FR. As another embodiment, the camera 241 and the radars 242 may be disposed upward of the headlight 18. The front wheel 16FR and a front wheel fender are generally placed under the headlight 18, and thereby it is possible to further enlarge the detectable ranges of the camera 241 and the radars 242.

Further, as can be seen from FIG. 2, in the present embodiment, the radar 243 is disposed rearward of a taillight 19 of the two-wheeled vehicle 1, and thereby it becomes possible to detect a traveling environment in rear without a detectable range of the radar 243 being narrowed by the taillight 19. Further, the radar 243 is more preferably disposed rearward of a rear wheel fender of the two-wheeled vehicle 1 as shown by a chain line in the drawing.

In the present embodiment, the separate driving assistance apparatus 2 further includes a connection mechanism 29, and the two-wheeled vehicle 1 and the separate driving assistance apparatus 2 are connected by the connection mechanism 29. The connection mechanism 29 is configured to allow for adjustment of a relative position in the longitudinal direction to the two-wheeled vehicle 1, of the separate driving assistance apparatus 2. Thereby, the relative position to the two-wheeled vehicle 1, of the separate driving assistance apparatus 2 can be adjusted so that positions of the above described camera 241 and the radars 242 and 243 are desired positions. Further, the connection mechanism 29 may be also capable of adjusting a relative position in a lateral direction to the two-wheeled vehicle 1, of the separate driving assistance apparatus 2. Thereby, a distance between the two-wheeled vehicle 1 and the separate driving assistance apparatus 2 can be adjusted according to a type of the two-wheeled vehicle 1.

In the present embodiment, signal communication between the control block 12 and the control block 22 described with reference to FIG. 3 is realized by the connection mechanism 29. For example, the connection mechanism 29 includes a pipe-shaped frame, and may contain a cable that realizes signal communication between the control block 12 and the control block 22. Note that the above described signal communication may be realized by Wi-Fi as another embodiment, that is, is realizable by either wire or wireless, and various communication standards can be used.

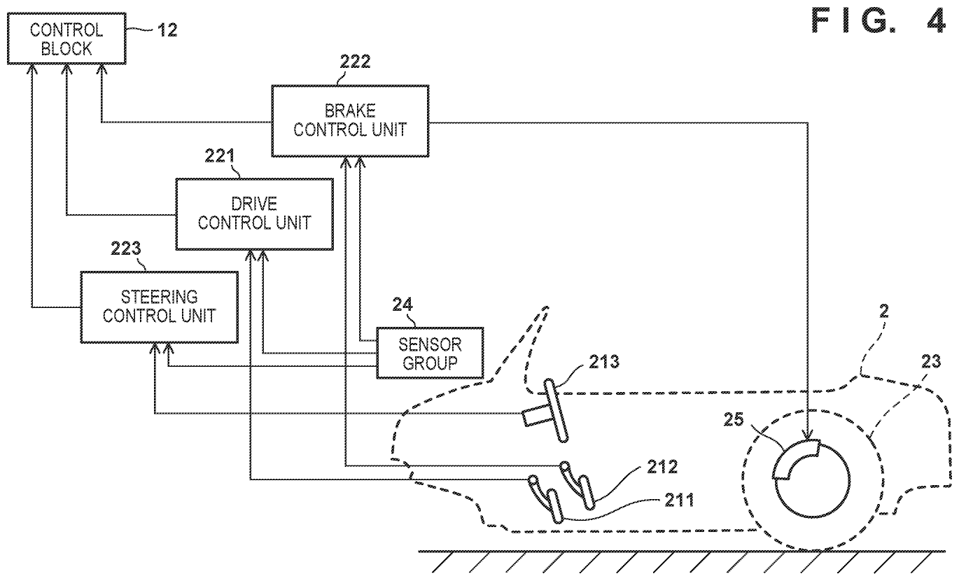

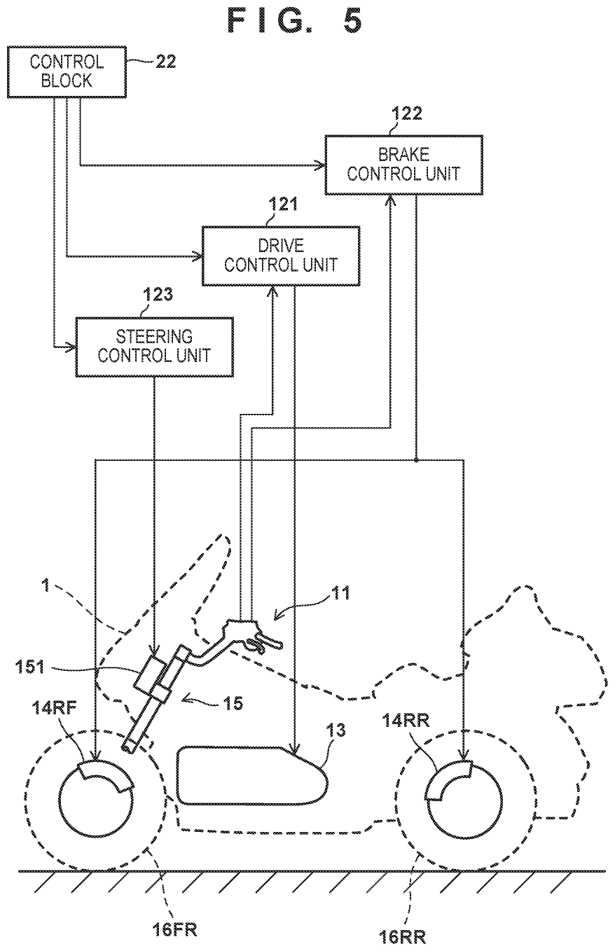

According to the configuration as above, the control block 22 of the separate driving assistance apparatus 2 can realize driving assistance by driving or controlling the respective mechanisms 13 to 15 via the control block 12 of the two-wheeled vehicle 1 based on the detection result by the sensor group 24. This will be described in more detail with reference to FIGS. 4 and 5.

FIG. 4 is a block diagram illustrating a control system by the control blocks 11 and 22, focusing on the separate driving assistance apparatus 2 side. FIG. 5 is a block diagram illustrating the control system by the control blocks 11 and 22, focusing on the two-wheeled vehicle 1 side.

Referring to FIG. 4, the separate driving assistance apparatus 2 includes the acceleration operator 211 and the braking operator 212 both of which are of a pedal type, and the steering operator 213 which is the steering wheel as described above. Thereby, the driver can perform a driving operation by using the operators 211 to 213 while the driver sits on the sheet SH2 (refer to FIG. 2). Based on the operation amounts of the operators 211 to 213, the control units 221 to 223 output control signals corresponding to the operation amounts to the control block 12 (the control units 121 to 123) of the two-wheeled vehicle 1.

Referring to FIG. 5, on the two-wheeled vehicle 1 side, the control units 121 to 123 receive the control signals from the control block 22 (the control units 221 to 223), and drive or control the mechanisms 13 to 15 respectively. For example, the drive control unit 121 receives the control signal from the drive control unit 221, and controls the drive mechanism 13, in the present embodiment, a throttle opening degree of an engine unit, or controls the transmission, and accelerates the two-wheeled vehicle 1. For example, the brake control unit 122 receives the control signal from the brake control unit 222, and controls the braking mechanism 14, in the present embodiment, disk brakes 14FR and 14RR which are respectively provided at the wheels 16FR and 16RR, and gives a braking force to the wheels 16FR and 16RR. Further, for example, the steering control unit 123 receives the control signal from the steering control unit 223, and controls the steering mechanism 15, in the present embodiment, a steering motor 151 that rotates the head pipe and the steering handle, and performs steering control (control of forward traveling, left turn, right turn, rotation and the like). The steering motor 151 can also function as an assist mechanism of steering at a time of normal driving.

In the present embodiment, as illustrated in FIG. 4, the separate driving assistance apparatus 2 further includes a disk brake 25 that realizes braking of the wheel 23, and the brake control unit 222 controls the disk brake 25 based on the operation amount of the braking operator 212 to give a braking force to the wheel 23. When the braking force is given to only the wheels 16FR and 16RR (the two-wheeled vehicle 1 side), yawing can occur by the separate driving assistance apparatus 2 traveling forward by inertia, for example, and according to the present embodiment, this can be prevented.

When the driving assistance function is used, the control units 221 to 223 output the control signals for controlling the respective mechanisms 13 to 15 to the control block 12 (the control units 121 to 123) based on the detection signals from the sensor group 24, and perform driving assistance. Since the separate driving assistance apparatus 2 is provided with the operating unit 21, the driver can respond to a handover request (a request to change the subject of the driving operation to the driver) from the control block 22 even when the driver sits on the sheet SH2. The handover request can be performed by a notification unit (for example, a speaker) not illustrated which is provided in the separate driving assistance apparatus 2, for example.

When two passengers ride on the sheets SH1 and SH2, it is possible to use the driving assistance function, and when the driving assistance state is cancelled, it is possible to change the subject of the driving operation between one passenger and the other passenger. In other words, according to the present embodiment, the respective passengers can take a break in turn while alternating the driving operation.

The respective elements provided for the two-wheeled vehicle 1 and the separate driving assistance apparatus 2 described above are only illustrations of the typical structure, and other structures may be adopted as other embodiments. For example, focusing on the separate driving assistance apparatus 2, a lever type and a button type may be used as the braking operator 212, instead of the pedal type. For example, instead of the wheel 23, an endless track (a so-called caterpillar) may be used, or it is also possible to help the two-wheeled vehicle 1 stand up by controlling the steering mechanism 15 by the steering control unit 223, without including the wheel 23. Further, although merely at least one of the operators 211 to 213 may be provided in the operating unit 21, a stop button that cancels the driving assistance state and stops the two-wheeled vehicle 1 may be provided alternatively/additionally.

Further, as another embodiment, the separate driving assistance apparatus 2 may further include a battery when the two-wheeled vehicle 1 is EV (Electric Vehicle). In that case, the separate driving assistance apparatus 2 can supply power to the two-wheeled vehicle 1 by the battery, and concurrently perform driving assistance. Further, as still another embodiment, the separate driving assistance apparatus 2 may further include a motor for performing electric drive of the two-wheeled vehicle 1 besides the above described battery.

(Rental Service of Separate Driving Assistance Apparatus)

The separate driving assistance apparatus 2 as described above is also usable as an object of a rental service. As an example, rental service on a highway is conceivable. For example, after riding on the two-wheeled vehicle 1 and enjoying touring and the like, the driver can take a break on a highway on a return road by renting the separate driving assistance apparatus 2 and using the driving assistance function. As another example, rental service for sightseeing is conceivable. For example, a driver rents the separate driving assistance apparatus 2 and uses the driving assistance function on a scenic touring course, and thereby the driver can enjoy the view.

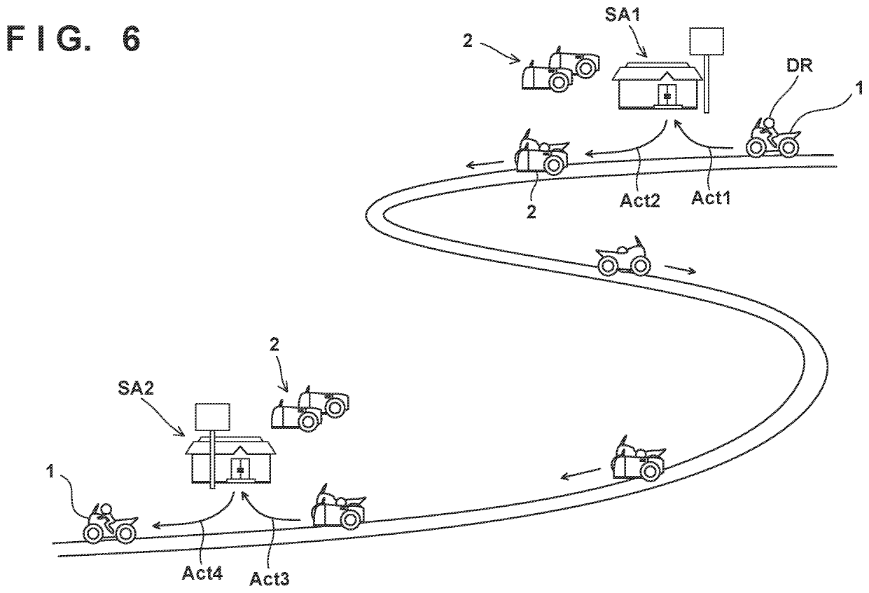

FIG. 6 illustrates a mode of the rental service on the highway described above. First, by an action Act1 (Hereinafter, simply referred to as “Act1”. The same also applies to other actions.), a driver DR traveling by the two-wheeled vehicle 1 on a highway on a return road stops at a service station (store) SA1. The driver DR rents the separate driving assistance apparatus 2 in the service station SA1, and connects the separate driving assistance apparatus 2 to the two-wheeled vehicle 1. Thereafter, by Act2, the driver DR rides on the separate driving assistance apparatus 2 and travels on the highway again. Here, the driver DR uses the driving assistance function, and thereby can take a break during this while.

Thereafter, by Act3, the driver DR reaches another service station SA2 with the two-wheeled vehicle 1 and the separate driving assistance apparatus 2 which are connected to each other, and stops at the service station SA2. The driver DR returns the separate driving assistance apparatus 2 at the service station SA2. Thereafter, by Act4, the driver DR performs a driving operation of the two-wheeled vehicle 1 again, and can go home.

According to the mode like this, the driver DR can take a break without performing a driving operation in a section from the service station SA1 to the service station SA2. Further, the driver DR can use the separate driving assistance apparatus 2 relatively inexpensively and easily.

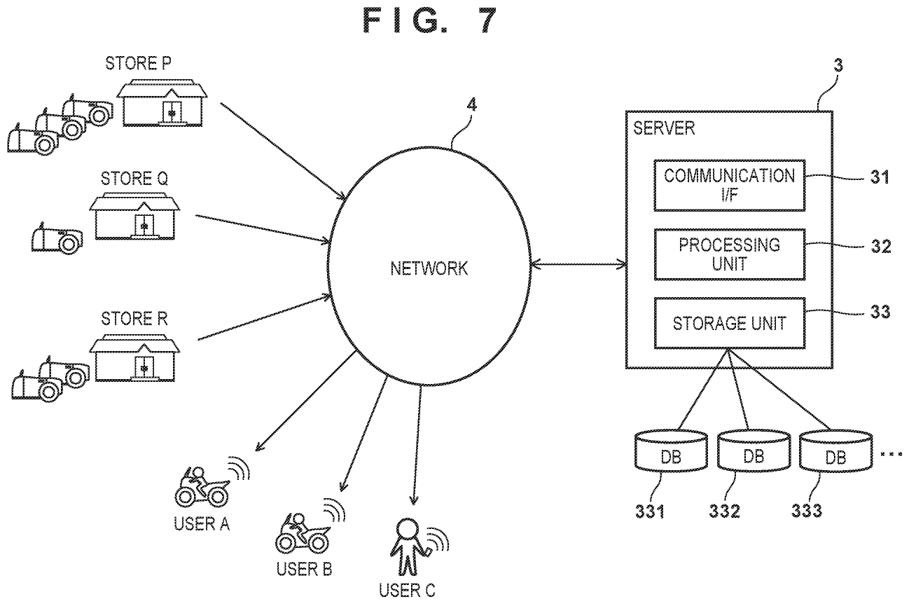

FIG. 7 is an example of a configuration diagram of a system that realizes the rental service of the separate driving assistance apparatus 2. In the present example, a head office of a rental service company is provided with a server 3, and the server 3 includes a communication interface 31, a processing unit 32 and a storage unit 33. The server 3 is capable of signal communication with respective stores P, Q and R (service stations in the case of a highway) by the communication interface 31 via a network 4. For example, the server 3 can receive inventory information of the separate driving assistance apparatus 2 such as the number of lendable separate driving assistance apparatuses 2, the lending situation of the driving assistance apparatus 2, and the return situation of the driving assistance apparatus 2 in the store P, via the network 4.

The processing unit 32 includes a CPU (central processing unit) and memories (RAM, ROM), and performs management of the inventory information of the separate driving assistance apparatus 2 about the respective stores P, Q and R based on a predetermined program. The storage unit 33 is, for example, a hard disk drive or the like, and stores inventory information of the separate driving assistance apparatuses 2 of the stores P to R respectively as databases 331 to 333 about the stores P to R.

For example, when lending of m apparatuses 2 occurs in the store P, information indicating the lending of the m apparatuses 2 is inputted to a store terminal by, for example, a store clerk, in the store P (m is an integer of 1 or more). The server 3 receives the information via the network 4, and updates the database 331 corresponding to the store P, that is, the inventory information about the store P by the processing unit 32. For example, when return of n apparatuses 2 occurs in the store Q, information indicating the return of the n apparatuses 2 is inputted to a store terminal by, for example, a store clerk, in the store Q (n is an integer of 1 or more). The server 3 receives the information via the network 4, and updates the database 332 corresponding to the store Q, that is, the inventory information about the store Q by the processing unit 32.

The server 3 transmits availability information of the apparatus 2 to users (The present example shows users A to C.) within predetermined ranges from the stores P to R, based on the inventory information of the stores P to R. Thereby, the above described rental service becomes easy to use for the users A to C. For example, the users A and B who are traveling on two-wheeled vehicles can refer to the availability information of the apparatus 2 by notification units (not illustrated) provided at the two-wheeled vehicles, and can stop at the stores where the apparatuses 2 are available. Further, for example, the user C who is now going to use the two-wheeled vehicle can refer to the availability information of the apparatus 2 by using an exclusive application of a mobile terminal (smartphone), and can also make a reservation for lending.

According to the present example, the separate driving assistance apparatus 2 is also applicable to rental business, and the separate driving assistance apparatus 2 can be used in various modes including the aforementioned examples (highway, sightseeing and the like).

### Summary of Embodiment

A first aspect is a separate driving assistance apparatus (for example, 2) connectable to a two-wheeled vehicle (for example, 1), and includes a detection unit (for example, 24) for detecting a traveling environment of the two-wheeled vehicle, and a control unit (for example, 22) that controls the two-wheeled vehicle to perform driving assistance of the two-wheeled vehicle based on a detection result by the detection unit.

According to the first aspect, it becomes possible to perform driving assistance (automatic control of some or all of the driving operations such as acceleration, braking and steering) of a two-wheeled vehicle such as a straddle type motorcycle.

In a second aspect, an auxiliary unit (for example, 23) that helps the two-wheeled vehicle to stand up is further included.

According to the second aspect, it becomes possible to stabilize traveling of the two-wheeled vehicle by helping the two-wheeled vehicle to stand up.

In a third aspect, the auxiliary unit is a wheel (for example, 23), and the wheel and two wheels (for example, 16FR, 16RR) of the two-wheeled vehicle enables the two-wheeled vehicle to stand up.

According to the third aspect, three-point grounding to a traveling surface is realized, and therefore it becomes possible to stabilize traveling of the two-wheeled vehicle.

In a fourth aspect, a seat (for example, SH2) on which a person can sit is further included.

According to the fourth aspect, in driving assistance, a driver can take a brake by sitting on the seat of the separate driving assistance apparatus.

In a fifth aspect, the separate driving assistance apparatus is a side car (for example, 2).

According to the fifth aspect, by using the side car including the driving assistance function, driving assistance of the two-wheeled vehicle is enabled with the relatively simple configuration.

In a sixth aspect, an operating unit (for example, 21) capable of controlling traveling of the two-wheeled vehicle is further included.

According to the sixth aspect, the driver can drive himself even when the driver sits on the seat of the separate driving assistance apparatus instead of the seat of the two-wheeled vehicle. Even when the driver sits on the seat of either the two-wheeled vehicle or the side car, for example, it becomes possible to cancel the driving assistance state and change (handover) the subject of the driving operation to the driver.

In a seventh aspect, the operating unit includes at least one of the acceleration operator (for example, 211), the braking operator (for example, 212) and the steering operator (for example, 213).

According to the seventh aspect, the separate driving assistance apparatus can handle various kinds of driving assistance.

In an eighth aspect, the operating unit is configured to enable two passengers to alternate a driving operation when the two passengers respectively ride on the separate driving assistance apparatus and the two-wheeled vehicle.

According to the eighth aspect, the respective passengers can take a break in turn by alternating the driving operation.

In a ninth aspect, the detection unit includes a plurality of sensors, and at least some (for example, 241, 242) of the plurality of sensors are disposed forward of a headlight (for example, 18) of the two-wheeled vehicle.

According to the ninth aspect, it becomes possible to detect the traveling environment in front without the detectable range being narrowed by light of the headlight or the headlight itself.

In a tenth aspect, the detection unit includes a plurality of sensors, and at least some (for example, 241, 242) of the plurality of sensors are disposed upward of a front wheel (for example, 16FR) of the two-wheeled vehicle.

According to the tenth aspect, it becomes possible to detect the traveling environment in front without the detectable range being narrowed by the front wheel.

In an eleventh aspect, the detection means includes a plurality of sensors, and at least some (for example, 243) of the plurality of sensors are disposed rearward of a taillight (for example, 19) of the two-wheeled vehicle.

According to the eleventh aspect, it becomes possible to detect the traveling environment in rear without the detectable range being narrowed by light of the taillight or the taillight itself.

In a twelfth aspect, a connection unit (for example, 29) with the two-wheeled vehicle is further included, and the connection unit is configured to allow for adjustment of a relative position to the two-wheeled vehicle, of the separate driving assistance apparatus.

According to the twelfth aspect, the separate driving assistance apparatus becomes applicable to various kinds of two-wheeled vehicles.

In a thirteenth aspect, the control unit controls a drive mechanism (for example, 13) of the two-wheeled vehicle.

According to the thirteenth aspect, the two-wheeled vehicle is accelerated by control of the transmission, and control of the throttle opening degree, for example.

In a fourteenth aspect, the control unit controls a braking mechanism (for example, 14) of the two-wheeled vehicle.

According to the fourteenth aspect, the two-wheeled vehicle is decelerated or stopped by controlling a disk brake, for example.

In a fifteenth aspect, the control unit controls a steering mechanism (for example, 15) of the two-wheeled vehicle.

According to the fifteenth aspect, forward traveling, left turn, right turn, rotation and the like of the two-wheeled vehicle are enabled by controlling a motor (for example, 151) provided in the steering mechanism, for example.

A sixteenth aspect is a server (for example, 3) for performing rental service of a separate driving assistance apparatus (for example, 2), and includes a storage unit (for example, 33) that stores inventory information indicating a number of lendable separate driving assistance apparatuses, a communication unit (for example, 31) that receives information on lending or return of separate driving assistance apparatuses from a store terminal, and an updating unit (for example, 32) that updates the inventory information stored in the storage unit based on the information received by the communication unit.

According to the sixteenth aspect, it is also possible to apply the separate driving assistance apparatus to rental business.

In a seventeenth aspect, the inventory information is transmitted to a two-wheeled vehicle (for example, 1) or a mobile terminal of a user of the two-wheeled vehicle by the communication unit.

According to the seventeenth aspect, the user easily uses the rental service of the separate driving assistance apparatus.

The present invention is not limited to the above embodiments and various changes and modifications can be made within the spirit and scope of the present invention. Therefore, to apprise the public of the scope of the present invention, the following claims are made.

### REFERENCE SIGNS LIST

1 two-wheeled vehicle
2 separate driving assistance apparatus
21 operating unit
22 control block
23 wheel
24 sensor group

1. A separate driving assistance apparatus connectable to a two-wheeled vehicle, the two-wheeled vehicle comprising a control block for controlling a driving operation, the separate driving assistance apparatus comprising:
a detection unit for detecting a traveling environment around the two-wheeled vehicle; and
a control unit that outputs a controlling signal to the control block of the two-wheeled vehicle based on a detection result by the detection unit, the controlling signal being for assisting driving operation of the two-wheeled vehicle.

2. The separate driving assistance apparatus according to claim 1, further comprising:
an auxiliary unit that helps the two-wheeled vehicle to stand up.

3. The separate driving assistance apparatus according to claim 2, wherein
the auxiliary unit is a wheel, and the wheel and two wheels of the two-wheeled vehicle enable the two-wheeled vehicle to stand up.

4. The separate driving assistance apparatus according to claim 1, further comprising:
a seat on which a person can sit.

5. The separate driving assistance apparatus according to claim 1, wherein
the separate driving assistance apparatus is a side car.

6. The separate driving assistance apparatus according to claim 4, further comprising:
an operating unit capable of controlling traveling of the two-wheeled vehicle.

7. The separate driving assistance apparatus according to claim 6, wherein
the operating unit includes at least one of an acceleration operator, a braking operator and a steering operator.

8. The separate driving assistance apparatus according to claim 7, wherein
the operating unit is configured to enable two passengers to alternate a driving operation when the two passengers respectively ride on the separate driving assistance apparatus and the two-wheeled vehicle.

9. The separate driving assistance apparatus according to claim 1, wherein
the detection unit includes a plurality of sensors, and
at least some of the plurality of sensors are disposed forward of a headlight of the two-wheeled vehicle.

10. The separate driving assistance apparatus according to claim 1, wherein
the detection unit includes a plurality of sensors, and
at least some of the plurality of sensors are disposed upward of a front wheel of the two-wheeled vehicle.

11. The separate driving assistance apparatus according to claim 1, wherein
the detection unit includes a plurality of sensors, and
at least some of the plurality of sensors are disposed rearward of a taillight of the two-wheeled vehicle.

12. The separate driving assistance apparatus according to claim 9, further comprising:
a connection unit with the two-wheeled vehicle,
wherein the connection unit is configured to allow for adjustment of a relative position to the two-wheeled vehicle in a longitudinal direction, of the separate driving assistance apparatus.

13. The separate driving assistance apparatus according to claim 1, wherein
the control unit controls a drive mechanism of the two-wheeled vehicle.

14. The separate driving assistance apparatus according to claim 1, wherein
the control unit controls a braking mechanism of the two-wheeled vehicle.

15. The separate driving assistance apparatus according to claim 1, wherein
the control unit controls a steering mechanism of the two-wheeled vehicle.

16. The separate driving assistance apparatus according to claim 1, wherein
the control unit outputs the controlling signal to the control block of the two-wheeled vehicle based on the traveling environment around the two-wheeled vehicle which is detected by the detection unit, regardless of whether a passenger rides on the separate driving assistance apparatus or the two-wheeled vehicle.

17. A server for performing rental service of the separate driving assistance apparatus according to claim 1, comprising:
a storage unit that stores inventory information indicating a number of lendable separate driving assistance apparatuses;
a communication unit that receives information on lending and return of separate driving assistance apparatuses from a store terminal; and
an updating unit that updates the inventory information stored in the storage unit based on the information received by the communication unit.

18. The server according to claim 17, wherein
the inventory information is transmitted to a two-wheeled vehicle or a mobile terminal of a user of the two-wheeled vehicle by the communication unit.
